(19) United States
(12) Patent Application Publication
(10) Pub. No.: US 2014/0211360 A1
(43) Pub. Date: Jul. 31, 2014

(54) SYSTEM AND METHOD FOR PRODUCING MAGNETIC STRUCTURES

(71) Applicant: Correlated Magnetics Research, LLC, Huntsville, AL (US)

(72) Inventors: Larry W. Fullerton, New Hope, AL (US); Mark D. Roberts, Huntsville, AL (US); Stephen D. Straus, Austin, TX (US)

(73) Assignee: Correlated Magnetics Research, LLC, Huntsville, AL (US)

(21) Appl. No.: 14/198,400

(22) Filed: Mar. 5, 2014

Related U.S. Application Data
(63) Continuation-in-part of application No. 13/659,444, filed on Oct. 24, 2012.
Application No. 13/659,444 is a continuation-in-part of application No. 13/687,819, filed on Nov. 28, 2012.
Application No. 13/687,819 is a continuation-in-part of application No. 13/959,201, filed on Aug. 5, 2013.
Application No. 13/959,201 is a continuation-in-part of application No. 14/052,891, filed on Oct. 14, 2013.
Application No. 14/052,891 is a continuation-in-part of application No. 14/045,756, filed on Oct. 3, 2013.
Application No. 14/045,756 is a continuation-in-part of application No. 13/240,335, filed on Sep. 22, 2011, now Pat. No. 8,648,681.
Application No. 13/240,335 is a continuation-in-part of application No. 12/476,952, filed on Jun. 2, 2009, now Pat. No. 8,179,219.
Application No. 12/476,952 is a continuation-in-part of application No. 12/895,589, filed on Sep. 30, 2010.
Application No. 12/895,589 is a continuation-in-part of application No. 12/885,450, filed on Sep. 18, 2010, now Pat. No. 7,982,568.
Application No. 12/885,450 is a continuation-in-part of application No. 12/476,952, filed on Jun. 2, 2009, now Pat. No. 8,179,219.
Application No. 14/045,756 is a continuation-in-part of application No. 13/246,584, filed on Sep. 27, 2011.
(60) Provisional application No. 61/851,614, filed on Mar. 11, 2013.
(60) Provisional application No. 61/717,444, filed on Oct. 25, 2011.
(60) Provisional application No. 61/629,806, filed on Nov. 28, 2011.
(60) Provisional application No. 61/742,260, filed on Aug. 6, 2012.
(60) Provisional application No. 61/795,352, filed on Oct. 15, 2012.
(60) Provisional application No. 61/744,864, filed on Oct. 4, 2012.
(60) Provisional application No. 61/403,814, filed on Sep. 22, 2010.
(60) Provisional application No. 61/462,715, filed on Feb. 7, 2011.
(60) Provisional application No. 61/277,214, filed on Sep. 22, 2009.
(60) Provisional application No. 61/277,900, filed on Sep. 30, 2009.
(60) Provisional application No. 61/278,767, filed on Oct. 9, 2009.
(60) Provisional application No. 61/279,094, filed on Oct. 16, 2009.
(60) Provisional application No. 61/281,160, filed on Nov. 13, 2009.
(60) Provisional application No. 61/283,780, filed on Dec. 9, 2009.
(60) Provisional application No. 61/284,385, filed on Dec. 17, 2009.
(60) Provisional application No. 61/342,988, filed on Apr. 22, 2010.

(51) Int. Cl. H01F 13/00

(52) U.S. Cl. CPC H01F 13/00
USPC 361/152

(57) ABSTRACT

A magnetizer for magnetizing magnetic field sources into a magnetizable material includes a magnetization subsystem, a motion control system, and a magnetizer control system. The magnetization subsystem includes a magnetizing inductor comprising a plurality of flat conductor layers and a plurality of insulating layers that form multiple turns of a coil having an aperture and a magnetization circuitry for applying a current to the magnetizing inductor to generate a magnetizing field having a high magnetic flux density in and near said aperture that is sufficient to magnetize said magnetizable material and having a low magnetic flux density elsewhere that is insufficient to substantially magnetize said magnetizable material. The motion control system moves at least one of the magnetizable material or the magnetizing inductor to position the aperture of the magnetizing inductor adjacent to one or more locations at a surface of the magnetizable material where the one or more magnetic field sources are magnetized into the magnetizable material. The one or more magnetic field sources have a first polarity exposed at the surface of the magnetizable material and a second polarity not exposed at the surface of the magnetizable material.

### RELATED APPLICATIONS

This patent application is a continuation in part of non-provisional application Ser. No. 13/659,444, filed Oct. 24, 2012, titled “A System and Method for Producing Magnetic Structures” by Fullerton et al. and claims the benefit under 35 USC 119(e) of provisional application 61/851,614, titled “A System and Method for Producing Magnetic Structures”, filed Mar. 11, 2013, by Fullerton et al.; Ser. No. 13/659,444 claims the benefit under 35 USC 119(e) of provisional application 61/717,444, titled “A System and Method for Producing Magnetic Structures”, filed Oct. 25, 2011 by Fullerton et al.

This patent application is also a continuation in part of non-provisional application Ser. No. 13/687,819, filed Nov. 28, 2012, titled “System and Method for Focusing Magnetic Fields” by Loum et al, which claims the benefit under 35 USC 119(e) of provisional application 61/629,806, titled “System and Method for Focusing Magnetic Fields”, filed Nov. 28, 2011, by Loum et al.

This patent application is also a continuation in part of non-provisional application Ser. No. 13/959,201, filed Aug. 5, 2013, titled “System and Method for Magnetization” by Fullerton et al, which claims the benefit under 35 USC 119(e) of provisional application 61/742,260, titled “System and Method for Focusing Magnetic Fields”, filed Aug. 6, 2012, by Fullerton et al.

This patent application is also a continuation in part of non-provisional application 14/052,891, filed Oct. 14, 2013, titled “System and Method for Demagnetization of a Magnetic Structure Region” by Fullerton et al, which claims the benefit under 35 USC 119(e) of provisional application 61/795,352, titled “System and Method for Demagnetization of a Magnetic Structure Region”, filed Oct. 15, 2012, by Fullerton et al.

This patent application is also a continuation in part of non-provisional application 14/045,756, filed Oct. 3, 2013, titled “System And Method For Tailoring Polarity Transitions of Magnetic Structures” by Fullerton et al. which claims the benefit under 35 USC 119(e) of U.S. Provisional Patent Application No. 61/744,864, titled “System And Method For Tailoring Polarity Transitions of Magnetic Structures”, filed Oct. 4, 2012, by Fullerton et al; Ser. No. 14/045,756 is a continuation-in-part of U.S. nonprovisional application Ser. No. 13/240,335, filed Sep. 22, 2011, titled “Magnetic Structure Production”, which claims the benefit of U.S. provisional patent application No. 61/403,814, filed Sep. 22, 2010, titled “System and Method for Producing Magnetic Structures” and U.S. provisional patent application No. 61/462,715, filed Feb. 7, 2011, titled “System and Method for Producing Magnetic Structures”; Ser. No. 13/240,335 is a continuation-in-part of U.S. nonprovisional application Ser. No. 12/476,952, filed Jun. 2, 2009, titled “Field Emission System And Method”; Ser. No. 13/240,335 is also a continuation-in-part of U.S. nonprovisional patent application Ser. No. 12/895,589 (filed Sep. 30, 2010), which is entitled “A System And Method For Energy Generation”, which claims the benefit of provisional patent application Nos. 61/277,214, filed Sep. 22, 2009, 61/277,900 filed Sep. 30, 2009, 61/278,767, filed Oct. 9, 2009, 61/279,094, filed Oct. 16, 2009, 61/281,160, filed Nov. 13, 2009, 61/283,780, filed Dec. 9, 2009, 61/284,385, filed Dec. 17, 2009, and 61/342,988, filed Apr. 22, 2010, Ser. No. 12/895,589 is a continuation-in-part of nonprovisional Ser. No. 12/885,450, filed Sep. 18, 2010, and nonprovisional Ser. No. 12/476,952, filed Jun. 2, 2009; Ser No. 14/045,756 is also a continuation-in-part of U.S. patent application Ser. No. 13/246,584, filed Sep. 27, 2011, which is entitled “System and Method for Producing Stacked Field Emission Structures”. The contents of the provisional patent applications, the contents of the nonprovisional patent applications, and the contents of the issued patents that are identified above are hereby incorporated by reference in their entirety herein.

### FIELD OF THE INVENTION

The present invention relates generally to a system and method for producing magnetic structures. More particularly, the present invention relates to a system and method for producing magnetic structures by magnetically printing magnetic sources (or maxels) onto magnetizable material.

### SUMMARY OF THE INVENTION

A magnetizer for magnetizing one or more magnetic field sources into a magnetizable material includes a first magnetization subsystem, the magnetization subsystem including a magnetizing inductor including a plurality of flat conductor layers and a plurality of insulating layers, the plurality of flat conductor layers and the plurality of insulating layers forming multiple turns of a coil, the magnetizing inductor having an aperture extending through the plurality of flat conductive material layers, and a magnetization circuitry for applying a current to the magnetizing inductor to generate a magnetizing field having a high magnetic flux density in and near the aperture that is sufficient to magnetize the magnetizable material and having a low magnetic flux density elsewhere that is insufficient to substantially magnetize the magnetizable material, a motion control subsystem for moving at least one of said magnetizable material or the magnetizing inductor to position the aperture of the magnetizing inductor adjacent to one or more locations at a surface of the magnetizable material where the one or more magnetic field sources are magnetized into the magnetizable material, the one or more magnetic field sources having a first polarity exposed at the surface of the magnetizable material and a second polarity not exposed at the surface of said magnetizable material, and a magnetizer control system for controlling the first magnetization subsystem and the motion control subsystem.

The magnetization circuitry may be a monopolar magnetization circuitry or a bipolar magnetizing circuitry.

The magnetizer control system may change the direction of the current applied to said magnetizing inductor.

The magnetizer control system may change the amount of said current applied to said magnetizing inductor.

The magnetizer may include a second magnetization subsystem.

Two magnetic field sources of said one or more magnetic field sources may be magnetized at substantially the same time.

The magnetizing inductor of the first magnetization subsystem and a magnetizing inductor of the second magnetization subsystem may be on opposite sides of the magnetizable material.

The magnetizer may include a monitoring device for monitoring a current waveform of the magnetizing inductor during magnetizing of said magnetizable material to produce current waveform characterization data.

The magnetizer may disable itself when said current waveform characterization data is determined to be outside an established threshold.

The magnetizer may include a sensor for measuring a physical parameter of one of a component of the magnetizer or the magnetizer's environment.

The magnetizer may include a camera.

A pattern of the one or more magnetic field sources can provide information.

The plurality of insulating layers can include uniformly sized particles placed into an insulating liquid that is then allowed to harden while the coil is compressed.

The uniformly sized particles can be one of a polymer, a glass, or a ceramic.

The insulating liquid can be one of an epoxy, an acrylic, a polymer, or solvent based.

The magnetizer may include a software configured to define the location, polarity, and field amplitude of each magnetic field source of the one or more magnetic field sources.

The magnetizer may include a fixture for holding the magnetizable material during magnetization of the one or more magnetic field sources.

The magnetizer may include at least one of a turn table or a conveyor system.

The magnetizer may include a magnetic shielding layer.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIGS. 1A and 1B depict an exemplary magnetizer;

FIG. 1C depicts removal of a printed magnetic structure from a fixture of the exemplary magnetizer;

FIGS. 2A through 2D depict exemplary conveyor system based magnetization systems;

FIG. 3A depicts an exemplary gantry assembly where print heads each have associated springs for applying a downward force onto magnetizable material;

FIG. 3B depicts an exemplary gantry assembly where print heads each have associated magnet pairs oriented to repel each other for applying a downward force onto magnetizable material;

FIG. 4A depicts an exemplary gantry assembly having a spring for applying a downward force onto magnetizable material;

FIG. 4B depicts an exemplary gantry assembly having an associated magnet pair oriented to repel each other for applying a downward force onto magnetizable material;

FIG. 5A provides an oblique projection view of an exemplary print head having a flat print surface;

FIGS. 5B and 5C depict side views of the print head of FIG. 5A printing on a magnetizable material having a flat surface and a convex surface, respectively;

FIG. 5D depicts an alternative print head shape where the various flat metal layers of the print head have a concave shape that conforms to a convex surface of a magnetizable material;

FIGS. 5E-5G depict another alternative print head shape where the various flat metal layers of the print head have a convex shape enabling the print head to come into contact with a magnetizable material having a convex shaped surface, flat surface, or a concave shaped surface;

FIG. 5H depicts yet another alternative print head shape where the various flat metal layers of the print head have a funnel-like shape;

FIG. 6A depicts an exemplary print head having an insulating layer on a first outer surface that corresponds to a magnetization surface;

FIG. 6B depicts an exemplary print head having an insulating layer on first and second outer surfaces;

FIG. 6C depicts an exemplary print head encompassed by an insulating layer;

FIG. 7A depicts a print head like that of FIG. 5B having a flat magnetic shielding layer beneath the print head;

FIG. 7B depicts a print head like that of FIG. 5H having a magnetic shielding layer that increases in thickness from its aperture to its outer boundary;

FIG. 7C depicts a print head like that of FIG. 5B having a flat magnetic shielding layer beneath the print head and a flat magnetic shielding layer on top of the print head;

FIG. 7D depicts a print head like that of FIG. 7C with a ferromagnetic core inside the hole of the print head;

FIG. 7E depicts an oblique projection view of a magnetic shielding layer having a slot from a central hole to its perimeter;

FIG. 7F depicts an exemplary print head encompassed by a magnetic shielding layer with a ferromagnetic core inside the hole of the print head;

FIG. 7G depicts an oblique projection view of the print head of FIG. 7F showing the slot in the magnetic shielding layer;

FIG. 8A depicts a print head like that of FIG. 6A having a flat magnetic shielding layer beneath the print head;

FIG. 8B depicts a print head like that of FIG. 6B having a flat magnetic shielding layer on top of the print head;

FIG. 8C depicts an exemplary print head encompassed by an insulating layer that is encompassed by a magnetic shielding layer;

FIG. 8D depicts an exemplary print head like that of FIG. 8C with a ferromagnetic core inside the hole of the print head;

FIGS. 9A and 9B depict an exemplary print head like that of FIGS. 5A-5C with an exemplary heat sink;

FIG. 9C depicts an exemplary print head like that of FIGS. 9A and 9B that is encompassed by an insulating layer that is encompassed by a magnetic shielding layer, where the insulating and magnetic shielding layers have holes corresponding to the aperture of the print head;

FIGS. 10A and 10B depict exemplary robotic arms that can be used to move a print head and/or a magnetizable material;

FIGS. 11A and 11B depict an exemplary rack mount magnetization module and rack mount system, respectively;

FIG. 12 depicts a conveyor-based magnetization system having an integrated magnetic field measurement device;

FIG. 13 depicts a magnetizer use management system;

FIGS. 14A and 14B depict an exemplary critical damping resistor; and

FIG. 15 depicts an exemplary bipolar magnetizing circuit in accordance with the invention.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

Certain described embodiments may relate, by way of example but not limitation, to systems and/or apparatuses for producing magnetic structures, methods for producing magnetic structures, magnetic structures produced via magnetic printing, combinations thereof, and so forth. Example realizations for such embodiments may be facilitated, at least in part, by the use of an emerging, revolutionary technology that may be termed correlated magnetics. This revolutionary technology referred to herein as correlated magnetics was first fully described and enabled in the co-assigned U.S. Pat. No. 7,800,471 issued on Sep. 21, 2010, and entitled “A Field Emission System and Method”. The contents of this document are hereby incorporated herein by reference. A second generation of a correlated magnetic technology is described and enabled in the co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. Pat. No. 8,179,219 issued on May 15, 2012, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581 issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568 issued Jul. 19, 2011 which is all incorporated herein by reference in its entirety. Material presented herein may relate to and/or be implemented in conjunction with energy generation systems and methods such as described in U.S. patent application Ser. No. 13/184,543 filed Jul. 17, 2011, which is all incorporated herein by reference in its entirety. Such systems and methods described in U.S. Pat. No. 7,681,256 issued Mar. 23, 2010, U.S. Pat. No. 7,750,781 issued Jul. 6, 2010, U.S. Pat. No. 7,755,462 issued Jul. 13, 2010, U.S. Pat. No. 7,812,698 issued Oct. 12, 2010, U.S. Pat. Nos. 7,817,002, 7,817,003, 7,817,004, 7,817,005, and 7,817,006 issued Oct. 19, 2010, U.S. Pat. No. 7,821,367 issued Oct. 26, 2010, U.S. Pat. No. 7,823,300 and U.S. Pat. No. 7,824,083 issued Nov. 2, 2011, U.S. Pat. No. 7,834,729 issued Nov. 16, 2011, U.S. Pat. No. 7,839,247 issued Nov. 23, 2010, U.S. Pat. No. 7,843,295, U.S. Pat. No. 7,843,296, and U.S. Pat. No. 7,843,297 issued Nov. 30, 2010, U.S. Pat. No. 7,893,803 issued Feb. 22, 2011, U.S. Pat. No. 7,956,711 and U.S. Pat. No. 7,956,712 issued Jun. 7, 2011, U.S. Pat. Nos. 7,958,575, 7,961,068 and 7,961,069 issued Jun. 14, 2011, U.S. Pat. No. 7,963,818 issued Jun. 21, 2011, and U.S. Pat. No. 8,015,752 and U.S. Pat. No. 8,016,330 issued Sep. 13, 2011 are all incorporated by reference herein in their entirety.

The number of dimensions to which coding can be applied to design correlated magnetic structures is very high giving the correlated magnetic structure designer many degrees of freedom. For example, the designer can use coding to vary magnetic source size, shape, polarity, field strength, and location relative to other sources in one, two, or three-dimensional space, and, if using electromagnets or electro-permanent magnets can even change many of the source characteristics in time using a control system. Various techniques can also be applied to achieve multi-level magnetism control. In other words, the interaction between two structures may vary depending on their separation distance. The possible combinations are essentially unlimited.

The present invention pertains to producing magnetic structures by magnetically printing magnetic pixels (or maxels) onto magnetizable material, which can be described as magnetizing spots or spot magnetization. It is enabled by a magnetizer that functions as a magnetic printer that is able to move a magnetizable material relative to the location of a magnetic print head (and/or vice versa) so that magnetic pixels (or maxels) can be printed onto (and into) the magnetizable material in a prescribed pattern. When the magnetizer is printing maxels, the print head is adjacent to the magnetizable material, where the maxel is printed (or magnetized) by the magnetic field emerging from the aperture of the print head instead of the magnetic field inside the aperture (i.e., hole) of the print head. Typically, the magnetizable material being spot magnetized is much greater in size than the size of the aperture of the print head and therefore the magnetizable material is unable to fit inside the hole of the print head (i.e., the print head, an inductor coil, doesn't surround the material being magnetized as do coils of most conventional magnetizers).

Characteristics of the print head can be established to produce a specific shape and size of maxel given a prescribed magnetization voltage and corresponding current for a given magnetizable material where characteristics of the magnetizable material can be taken into account as part of the printing process. The printer can be configured to magnetize in a direction perpendicular to a magnetization surface, but the printer can also be configured to magnetize in a direction non-perpendicular to a magnetization surface.

A magnetic printer having a print head, which is also referred to as an inductor coil, is described in U.S. patent application Ser. No. 12/476,952, filed Jun. 2, 2009, titled “A Field Emission System and Method”, which is incorporated herein by reference. An alternative print head design is described in U.S. patent application Ser. No. 12/895,589, filed Sep. 3, 2010, titled “System and Method for Energy Generation”, which is incorporated herein by reference. Another alternative print head design is described in relation to FIGS. 19A through 19P of U.S. patent application Ser. No. 13/240,335, filed Sep. 22, 2011, titled “Magnetic Structure Production”, which is incorporated herein by reference.

In accordance with the invention, the magnetizing field needs to be constrained to a small geometry at the point of contact with the material to be magnetized in order to produce a sharply defined maxel. Two principals were considered in the development of the magnetic circuit and magnetic printing head previously described. First, magnetizable materials may acquire their permanent magnetic polarization very rapidly, for example, in microseconds or even nanoseconds for many materials, and second, Lenz's Law causes conductors to exclude rapidly changing magnetic fields, i.e. such rapidly changing fields are not permitted to penetrate a good conductor by a depth called its “skin depth”. Because of these two principals the magnetizing circuit used with the exemplary print head described herein creates a large current pulse of 0.8 ms duration that has a bandwidth of about 1250 KHz, which yields a calculated skin depth of about 0.6 mm. As previously described, print heads can be designed to produce different sized maxels having different maxel diameters, for example, 4 mm, 3 mm, 2 mm, 1 mm, etc, where maxel diameter can also be greater than 4 mm or smaller than 1 mm. The exemplary print head previously described has a aperture in the center about 1 mm diameter and the thickness of the assembly is about 1 mm, so during the printing of a maxel a majority of the field lines are forced to traverse the aperture rather than permeate the copper plates (or layers) that make up the head. Therefore this combination of magnetization pulse characteristics and print head geometry creates a magnetizing field having a very high flux density in and near the 1 mm aperture in the head and very low magnetic flux elsewhere resulting in a sharply defined maxel having approximately 1 mm diameter.

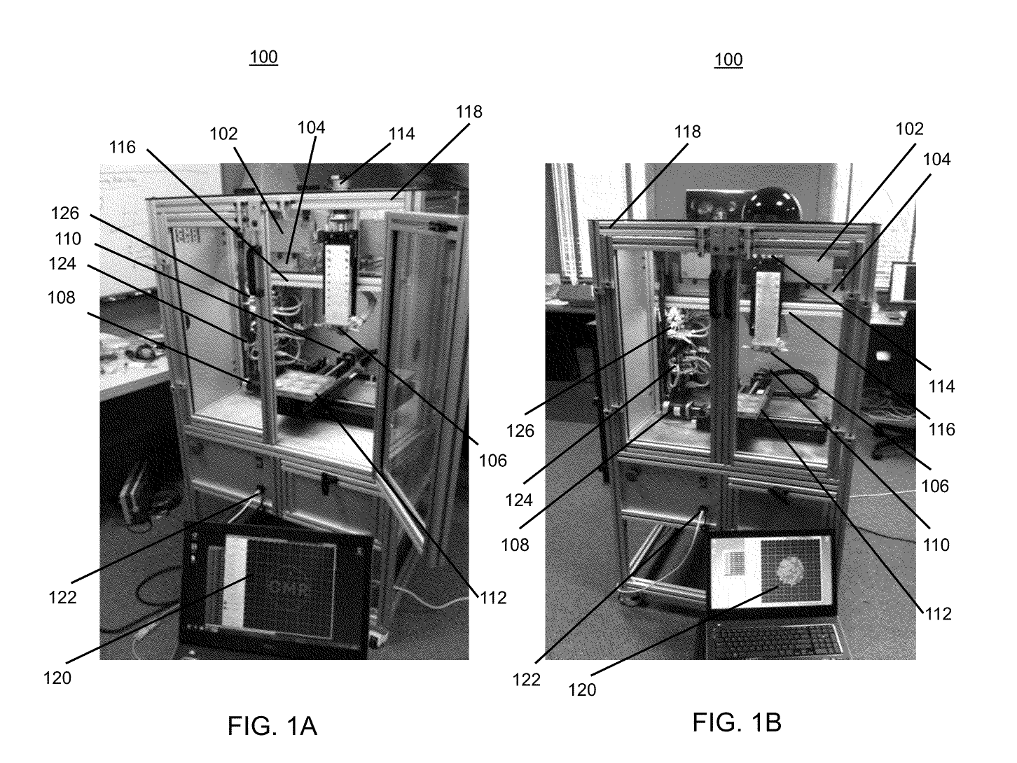

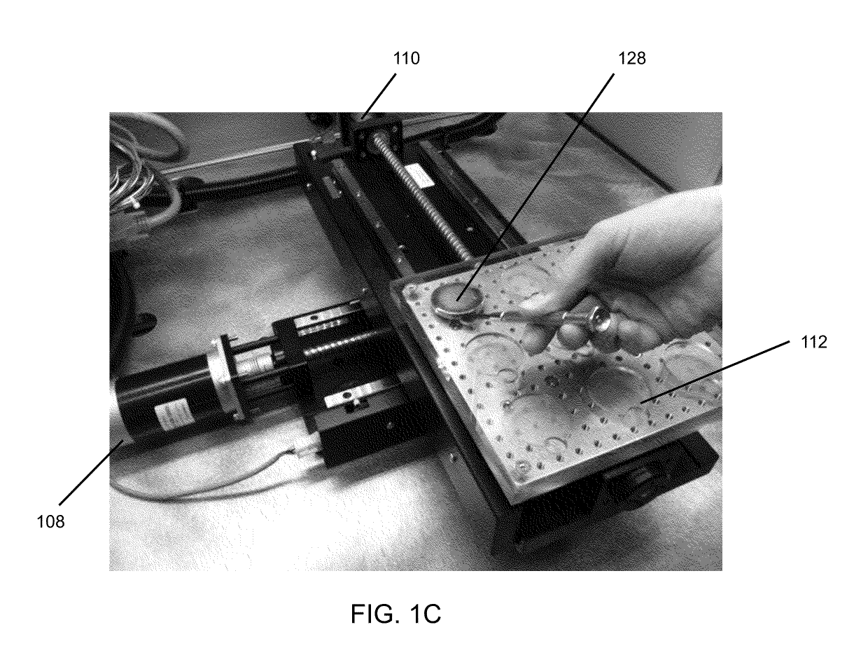

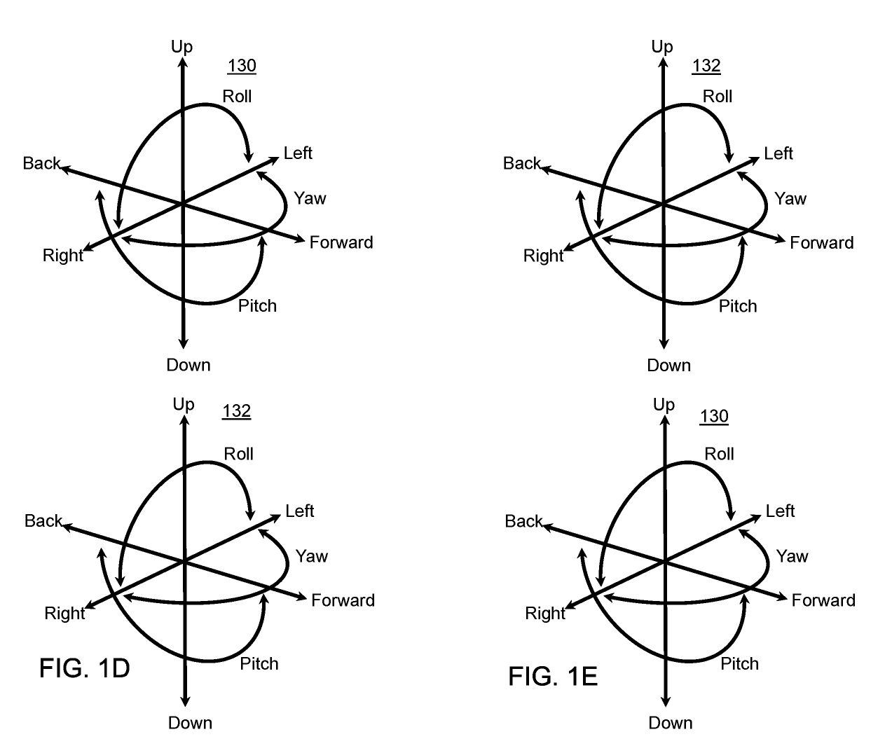

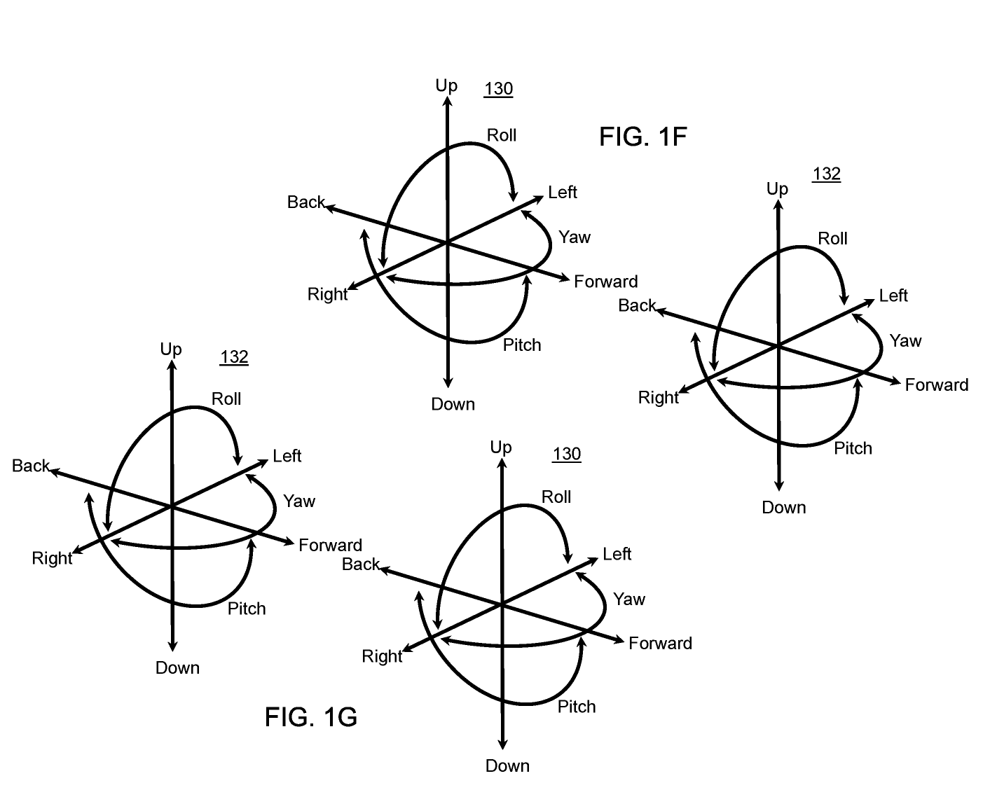

As previously mentioned above, the present invention is enabled by a magnetizer that functions as a magnetic printer that is able to move a magnetizable material relative to the location of a print head (and/or vice versa) so that magnetic pixels (or maxels) can be printed in a prescribed pattern. One embodiment of the magnetizer of the present invention is depicted in FIGS. 1A through 1C where both the location of a print head 106 and the location of a magnetizable material 128 are moved to print the prescribed pattern. Specifically, a print head is moved up and down in a Z-axis relative to magnetizable material in a fixture that is moved about in an X-Y plane. Referring to FIGS. 1A and 1B, magnetizer 100 comprises a magnetization subsystem comprising power supplies 102 used to charge capacitors 104 used to produce current through a print head 106. Not shown are switching circuitry comprising silicon controlled rectifiers (SCRs) used to control the polarity of the current passing through the print head 106 and thus the polarity of a given printed maxel. The amount of voltage used to charge the capacitors determines the amount of current passed through the print head 106 and thus the field strength of a given printed maxel.

The magnetizer 100 further comprises a motion control subsystem for moving the magnetizable material. The motion control subsystem comprises an X-axis servo motor 108, for example, a brushless servo motor, that controls movement of a first linear motion screw drive unit and a Y-axis servo motor 110 that controls movement of a second linear motion screw drive unit. Together the X-axis servo motor 108 and the Y-axis servo motor 110 control movement within the X-Y plane of a fixture 112 containing magnetizable material. The fixture 112 shown has slots for holding nine 1.5″ diameter×⅛″ thick disc-shaped portions of magnetizable material such as Neodymium Iron Boron (NIB) magnetizable material 128, which may be conventionally magnetized (e.g., axially, diametrically, or radially) or non-magnetized (e.g., a demagnetized magnet) prior to the magnetizer 100 printing a maxel pattern. FIG. 1C depicts a magnetic structure 128 being removed from the fixture 112 of FIGS. 1A and 1B. The slots may be sized such that a magnetizable material fits snugly in the slot and will not move during magnetization. Various other shaped fixtures can be used for holding magnetizable material 128 of different shapes such as square shapes, rectangular shapes, ring shapes, etc. A fixture may depend on one or more of various types of attachment mechanisms to keep magnetizable material from moving during printing. An attachment mechanism may comprise, for example, a set screw, a clamp, or a vacuum. A given fixture can be attached to an X-Y table using conventional magnets (i.e., magnet on magnet or magnet on metal) or correlated magnetic structures.

The motion control system of the magnetizer 100 also comprises a Z-axis servo motor 114 for moving the print head 106 up and down in the Z-axis. As such, during operation, a given X-Y location on a given portion of the magnetizable material is moved beneath the print head 106 which is then lowered to a Z location that is in contact with or in close proximity to the surface of the magnetizable material 128. The magnetization subsystem is charged and then a short pulse (e.g., 800 microseconds) of current is passed through the print head 106 thereby causing the print head 106 to magnetize (or print) a maxel into the magnetizable material at the given X-Y location. One skilled in the art will recognize that by programmatically moving and controlling the locations of the print head 106 and the fixture 112 (and thus the magnetizable material 128) and by controlling the direction and amount of current passing through the print head 106 that magnetic structures 128 having different maxel patterns can be produced whereby the characteristics (e.g., polarity and field strength) of each printed maxel can be controlled on a maxel-by-maxel basis.

Also shown in FIGS. 1A and 1B is a gantry 116 for supporting the print head 106, where the gantry 116 is attached to an enclosure 118. For this embodiment, the gantry 116 supports a moveable print head 106 whereby the Z-axis servo motor 114 is attached to the gantry 116 and the print head is attached to the Z-axis servo motor 114. In an alternative embodiment, the Z-axis servo motor is not required where a print head 106 is attached directly to the gantry 116 thus having a fixed location that is located substantially near or in contact with the magnetizable material when it is moved beneath the print head.

The magnetizer 100 can be controlled by a computer 120, for example a laptop computer as shown, which can be connected directly to the magnetizer 100 via an Ethernet port 122 or can be indirectly connected via a network having connections, for example Ethernet connections, with the computer 120 and the magnetizer 100. The computer 120 controls a motion controller 124, for example a Galil motion controller, for controlling the motion subsystem and a SCR trigger circuit board 126 used to control the magnetization subsystem. In FIGS. 1A and 1B, the motion controller 124 and SCR trigger circuit board 126 are hidden beneath wiring used to attach them to the motion control and magnetization subsystems.

The magnetizer 100 of FIGS. 1A-1C is configured to print on a flat surface of a magnetizable material 128. A magnetizer can also be configured to print on non-flat surfaces or on either flat or non-flat surfaces. Generally, a print head 106 can be configured to have no movement or any of one or more of six degrees of freedom of movement 130 (i.e., back, forward, right, left, pitch, roll, and yaw) and a magnetizable material 128 can be configured to have no movement or any of one or more of six degrees of freedom of movement 132, where at least one of the print head 106 or the magnetizable material 128 must be able to move to print a maxel pattern involving a plurality of different maxel locations on the magnetizable material 128. Moreover, the movement 130 of the print head 106 relative to the movement 132 of the magnetizable material 128 can be relative to each other in many different configurations such as those depicted in FIGS. 1D through 1I. FIG. 1D, for example, depicts a print head moving on top of a moving material, which is consistent with the magnetizer of FIGS. 1A-1C, where the print head has two degrees of freedom (up and down) and the fixture has four degrees of freedom (back, forward, right, and left). FIG. 1E depicts a print head moving beneath a moving magnetizable material. FIGS. 1D and 1E could also be combined, for example, where moveable print heads are both above and below a magnetizable material. Similarly, a print head may move behind a moving magnetizable material, and/or vice versa, as depicted in FIGS. 1F and 1G, or to the right and/or left of a magnetizable material, as depicted in FIGS. 1H and 1I. Generally, one skilled in the art of automation will understand that all sorts of relative movement configurations are possible to enable printing of a pattern of maxels on different shapes of magnetizable material.

Although the magnetizer 100 depicted in FIGS. 1A-1C includes only one print head 106, multiple print heads 106 can be employed, where in a preferred embodiment, each of the print heads 106 will be driven by a separate magnetization subsystem (i.e., voltage supply(s), capacitor(s), and SCR(s), etc.). By using multiple print heads 106 associated with a single gantry 116 or with multiple gantries 116, a magnetizer 100 can be configured to print multiple maxels at the same time or at overlapping times. For example, one print head may be printing while another print head(s) is charging or moving. A given print among multiple print heads may be configured to always print the same type maxel, for example, a maxel with a given polarity and field strength. Alternatively, a given print head may be configured to print the same class of maxel, for example, maxels of a constant polarity where field strength can vary or maxels of a constant field strength where polarity can vary, or a given print head may be configured to vary both polarity and field strength. One skilled in the art will recognize that if a given maxel characteristic is not required to vary then magnetization circuitry can be simplified (e.g., dedicated for a specific maxel type or class of maxel). The use of multiple print heads may involve using print heads having various sizes or shapes that together are capable of producing different sizes and/or shapes of maxels. For example, a magnetizer 100 might have four different sized print heads for printing 1 mm, 2 mm, 3 mm, and 4 mm diameter round maxels, or print heads capable of printing rectangular maxels might be used alongside print heads capable of printing round maxels or some other shape (e.g., square or hexagonal). Generally, all sorts of multiple print head and multiple magnetization subsystem combinations are possible to support printing large scale numbers of magnetic structures, in particular large numbers of magnetic structures each comprising the same maxel pattern. For example, multiple print heads might be configured to rotate into a printing position much like a rotating lens turret on an early television camera could bring any of several lenses in front of the camera shutter.

In an alternative arrangement, the magnetizable material can be held in a fixed location and a motion control subsystem can be attached to the gantry 116 thereby enabling the print head to be moved along one or more of an X-axis, Y-axis, and X-axis. Moreover, multiple motion control subsystems can be used on the same gantry to control movement of multiple print heads and/or multiple motion control subsystems can be used with multiple gantries (i.e., one or more per gantry) to control multiple print heads. In yet another alternative embodiment, one or more servo motors can be used to rotate a fixture relative to a given print head and/or a given print head relative to a fixture in which case the magnetizer can be configured to print on a non-flat surface such as on the side of disc-shaped magnetizable material. Generally, one skilled in the art of servo motors and actuators in general will recognize that all sorts of configurations are possible for moving a print head and/or magnetizable material relative to each other to support printing maxels on flat or non-flat surfaces and also to support printing (magnetization) in a direction other than perpendicular to a surface.

In still another embodiment, multiple fixtures for holding magnetizable material can be employed, for example, a rotatable turn table might be used such that while one set of magnetic structures in one fixture is being printed, another fixture of magnetic structures could be removed from the turn table, and another fixture having magnetizable material ready to be printed could be added to the turn table. After a given fixture of magnetic structures has been printed, the turn table would rotate the next fixture into place for printing, and the process of printing, removing, and adding magnetizable material would then be repeated. One skilled in the art will recognize that the removing and adding of the fixtures can be performed manually or automatically, for example, by a robotic arm(s).

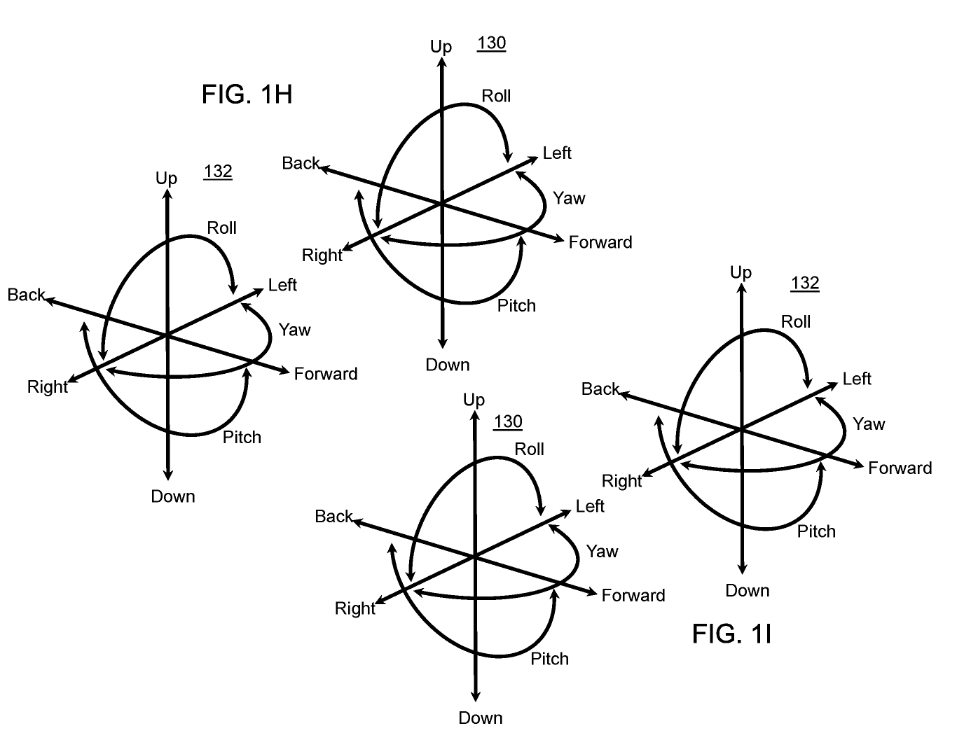

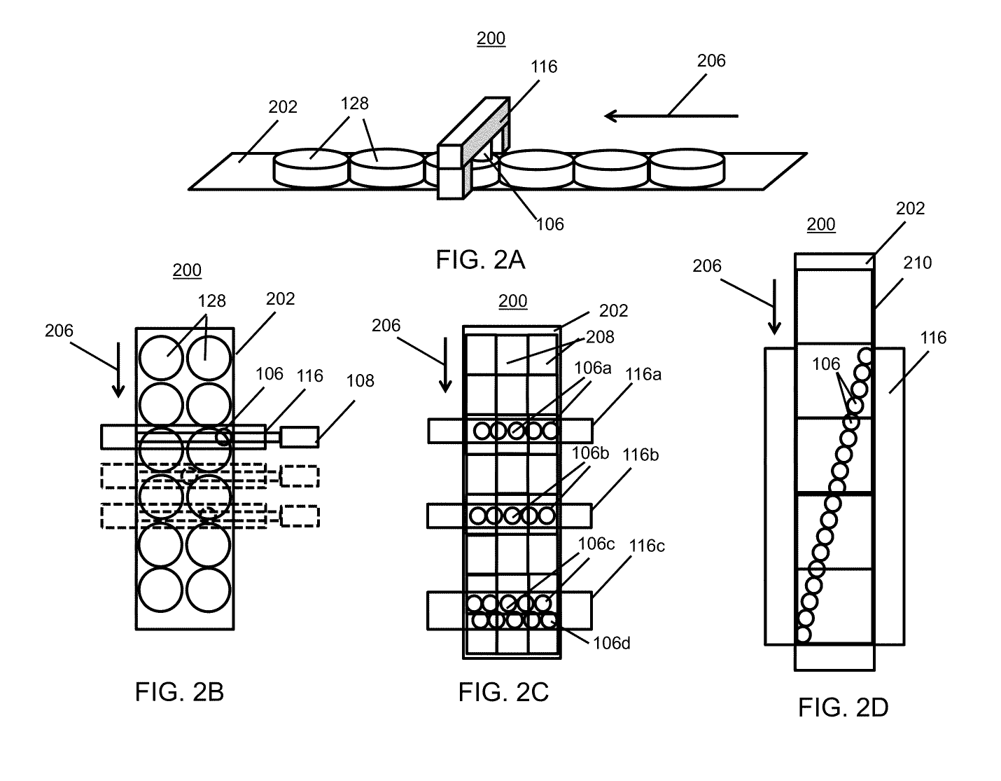

To support high speed manufacturing, one or more conveyor systems may be employed to move magnetizable material as part of a magnetization system. There are many well-known types of conveyor systems that could be used including conveyor-belt systems, roller conveyor systems, and the like. FIGS. 2A through 2D depict exemplary conveyor-based magnetization systems. Referring to FIG. 2A, a conveyor-based magnetization system 200 comprises at least one conveyor system 202 that moves magnetizable material, for example disc shaped magnetizable material 128, in a certain direction 206 such that the magnetizable material, for example discs 128, are brought into proximity of at least one print head 106 associated with at least one gantry 116. Although, the magnetizable material 128 is shown residing directly on the conveyor system 202, the magnetizable material 128 could be placed in a tray(s) or as fixture(s) residing on the conveyor system 202 or a tray/fixture(s) integrated with the conveyor system 202. In a preferred embodiment, the trays (or fixtures) are attached to the conveyor system using magnets, which can be conventional magnets or correlated magnetic structures designed for precision alignment.

FIG. 2B depicts at least one gantry having a print head 106 that is movable in a direction perpendicular to the direction of movement 206 of the conveyor system 202, where the print head 106 can move along a gantry 116 as controlled by an X-axis servo motor 108 and the direction of movement 206 of the conveyor system corresponds to a Y direction. As such, a given disc shaped magnetizable material 128 has a fixed X location and moves in the Y direction due to the conveyor system. A given moveable print head 106 moves across the magnetizable material and prints maxels. As depicted, multiple gantries 116 can be employed each having one or more movable print heads 106 associated with an X-axis servo motor.

FIG. 2C depicts three fixed gantries 116a, 116b, and 116c each having four rows of five print heads 106a, 106b, 106c, and 106d, respectively, where the print heads of each of the row are in various fixed locations that are offset from each other so as to provide coverage across consecutive rows of three side-by-side pieces of rectangular magnetizable material 208 passing beneath the gantries 116a, 116b, and 116c on the conveyor system 202. As the rectangular magnetic material 208 moves past the rows of print heads in a given direction 206, up to five maxels are printed in each row. The offsetting of the print heads in the multiple rows allow multiple maxels to be printed in a given row at substantially the same time where all maxels in a given row will have been printed after maxels have been printed by the fourth row of print heads 106d. Similarly, FIG. 2D depicts a large gantry 116 having print heads 106 that are offset across a diagonal, where each print head 106 addresses a different column of maxels as square shaped magnetizable materials pieces 210 move down the conveyor system 202 in a given direction 206. As such, once the magnetizable materials 210 have moved past the last print head 106, all rows and columns of maxels of a maxel pattern will have been printed.

A given fixture holding one or pieces of magnetizable material may pass through a given gantry configuration multiple times where different maxels of a desired maxel pattern are printed on the one or pieces of magnetizable material with each pass. Moreover, non-fixtured or fixture magnetizable material may be turned (e.g., turned over, rotated, etc.) between passes through a given gantry (or gantries) using various well know processes such that a given pass may print maxels on one side of the material and another pass may print on a different side of the material (e.g., an opposite side). Under one arrangement, a maxel pattern is printed on one side of a material and a corresponding mirror image of the maxel pattern (i.e., negative polarity maxels beneath positive polarity maxels and vice versa) is printed on an opposite side of a material where the opposing positive and negative polarity maxels each form a magnetic dipole through the material. Such an arrangement may be desirable to achieve desired saturation of a material (e.g., a thick material vs. a thin material).

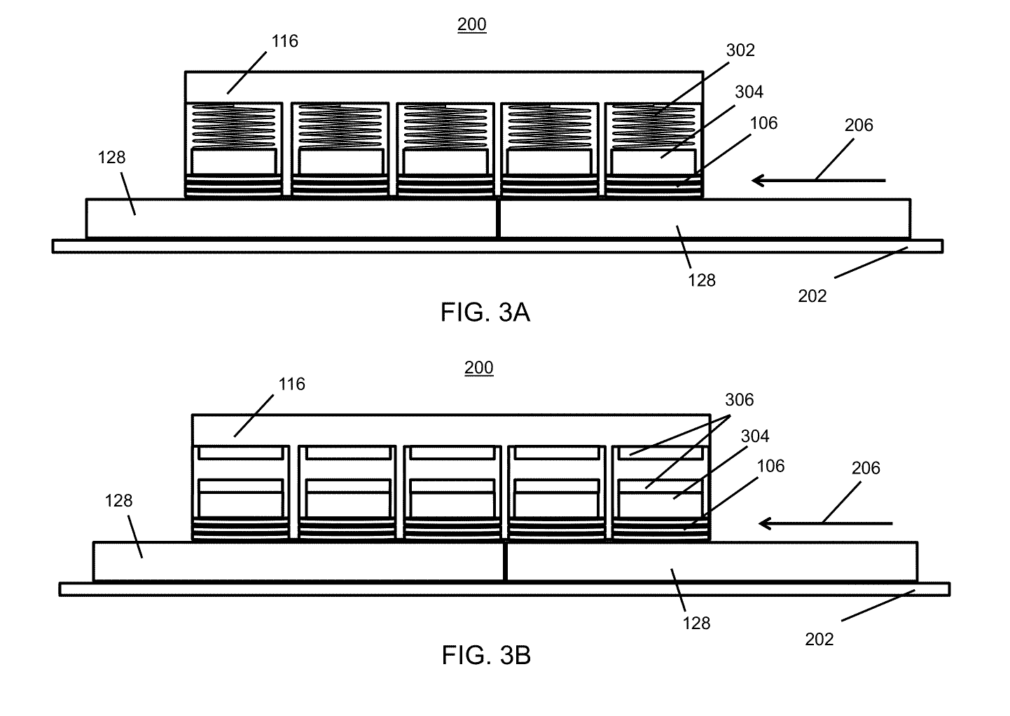

FIG. 3A depicts an exemplary gantry assembly 200 where print heads each have associated springs for applying a downward force onto magnetizable material. Referring to FIG. 3A, a conveyor system 202 is used to move magnetizable material 128 in a direction 206 past a gantry 116 in a fixed position having multiple print heads 106 configured to move independently. Specifically, each of the print heads 106 is attached to a connector 304 that is attached to a spring 302 that is attached to the gantry 116. Each spring 302 applies a force to maintain a desired force between a corresponding print head 106 and the magnetizable material 128.

FIG. 3B depicts an exemplary gantry assembly 200 where print heads 106 each have associated magnet pairs 306 oriented to repel each other for applying a downward force onto magnetizable material 128. As such, the respective repelling magnet pairs 306 of FIG. 3B act much like the springs 302 of FIG. 3A. The magnetic pairs 306 can be conventional magnets or can be correlated magnetic structures

For the exemplary gantry assemblies 200 of FIGS. 3A and 3B, travel limits can be employed to the print heads to ensure that their movement by the sprints 302 or magnet pairs 306. For example, the print head can be prevented from moving past a certain position, for example travel could be limited to 0.005″ below the surface of the magnetizable material.

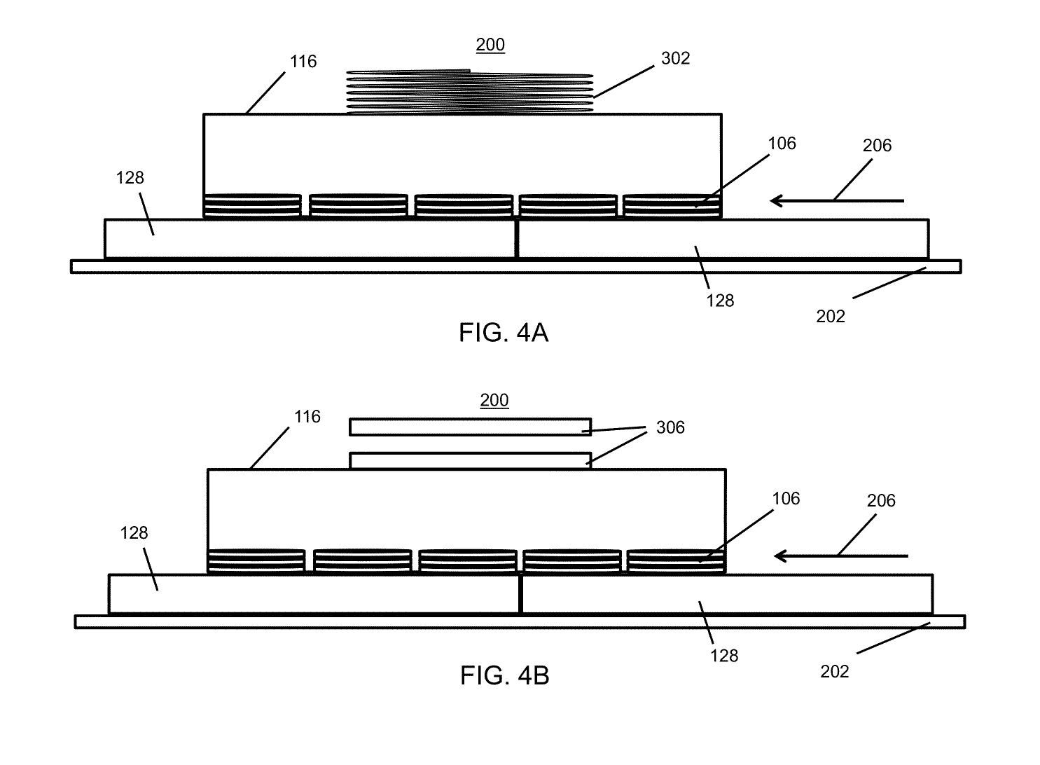

FIG. 4A depicts an exemplary gantry assembly 200 having a spring 302 for applying a downward force onto magnetizable material 128. Essentially, the difference between the gantry assemblies 200 of FIGS. 3A and 4A is that the print heads are able to move independent of each other in the gantry assembly 200 of FIG. 3A and the print heads are fixed and move together in the gantry assembly 200 of FIG. 4A.

FIG. 4B depicts an exemplary gantry assembly 200 having an associated magnet pair 306 oriented to repel each other for applying a downward force onto magnetizable material 128, where the print heads are fixed and move together as is the case with those in the gantry assembly 200 of FIG. 4A.

Generally, one skilled in the art will recognize that one or more conveyor systems can be used with one or more gantries having various configurations of one or more fixed or movable print heads to increase the speed at which maxels of a given magnetic structure can be printed on to magnetizable material. As previously described, the use of multiple print heads enables printing of different types of maxels, use of less flexible stream-lined components, etc. There are also various other methods other than conveyor systems for moving magnetizable material such as tubes, barrels, handling robots, and the like. Generally, all sorts of well-known material handling methods can be employed to move magnetizable material in accordance with the present invention.

As previously described, trays or fixtures can be used to contain magnetizable material on a conveyor system, which would make the material friendlier to pick and place machines. The trays/fixtures could be held onto the conveyor system with magnets to include correlated magnets that could be decorrelated for easy detachment.

Under one arrangement of the invention, magnetizable material can be transferred from one conveyor system to another conveyor system. Any of several well-known methods for transferring the magnetizable material including automated sorting equipment, pick and place equipment, and the like could be used. For example, a tray of printed magnetic structures could move to a location on a first conveyor system where the magnetic structures would be removed from the tray using pick and place equipment and the tray would move over to a second conveyor system where it would receive magnetizable material to be magnetized, and so on.

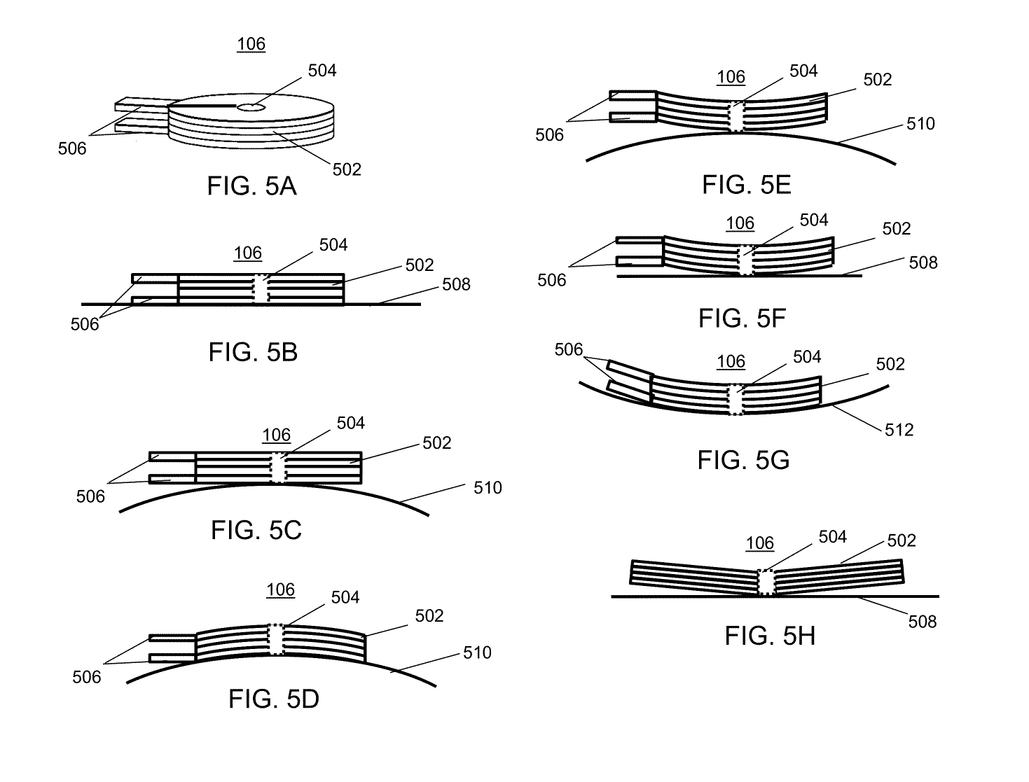

In accordance with the present invention, the shape of the print head may or may not conform to different shaped surfaces. FIG. 5A provides an oblique projection view and FIGS. 5B and 5C provide side views of a print head 106 having a flat print surface (i.e., the surface that would typically come into contact with the surface of a magnetizable material). Specifically, the print head 106 of FIGS. 5A-5C comprises a multiple turn flat metal (e.g., copper) coil 502 having tabs 506 for connecting to wiring of a magnetization subsystem. The multiple turn flat metal coil 502 includes a aperture 504 in which a magnetic field is produced to print a maxel into the magnetizable material, where the magnetizable material may have a flat surface 508 substantially parallel to the flat print surface of the print head 106 such as depicted in FIG. 5B. Alternatively, the print head 106 can be brought into contact and print a maxel onto magnetizable material having a convex surface 510 such as depicted in FIG. 5C. FIG. 5D depicts an alternative print head shape where the various flat metal layers of the print head have a concave shape that conforms to a convex surface 510 of a magnetizable material. FIGS. 5E-5G depict another alternative print head shape where the various flat metal layers of the print head have a convex shape enabling the print head to come into contact with a convex shaped surface of a magnetizable material such as in FIG. 5E but also flat and concave shaped surfaces of magnetizable material such as shown in FIGS. 5F and FG, respectively. FIG. 5H depicts yet another alternative print head shape where the various flat metal layers of the print head have a funnel-like shape. Generally, one skilled in the art will recognize different print head shapes can be used in accordance with the present invention.

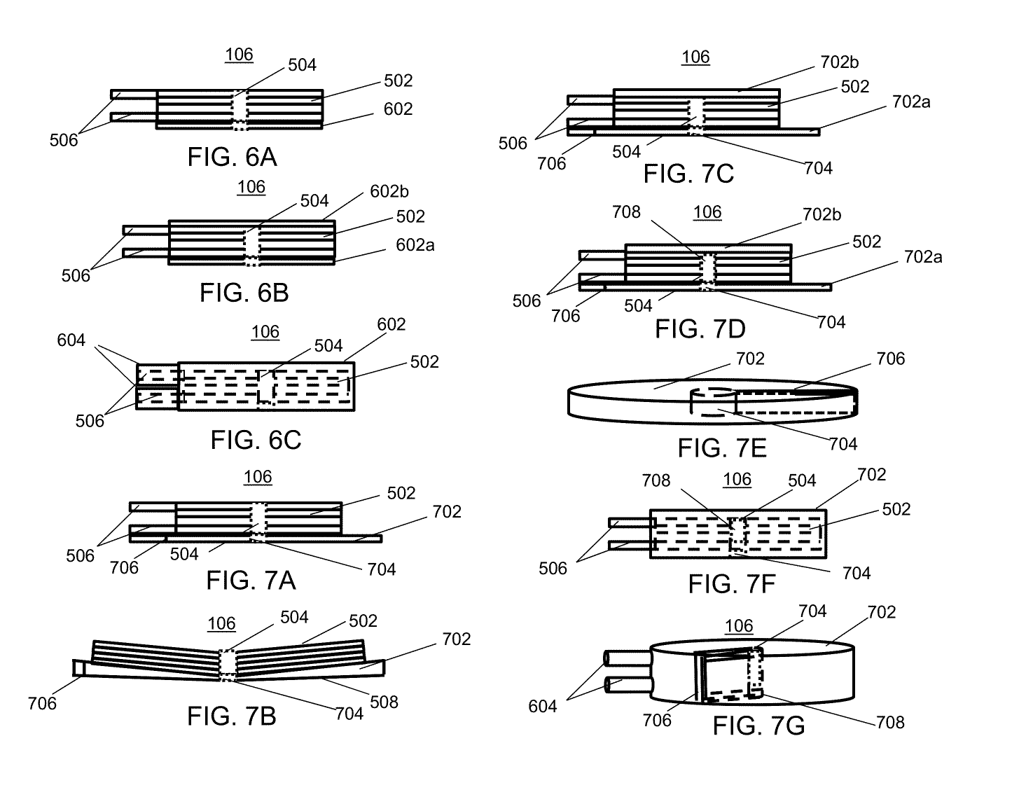

FIG. 6A depicts an exemplary print head 106 having an insulating layer 602 (e.g., Kapton) on a first outer surface that corresponds to a magnetization surface. As shown, a the insulating layer 602 is on the bottom of the print head 106 and is intended to insulate the bottom flat metal layer of the multi turn flat metal coil 502 from magnetizable material upon which the print head would be placed during printing. As depicted, the insulating layer 602 has a hole that corresponds to the aperture of the print head 504. However, the hole is not in the insulating layer is not required given the insulating layer has no effect on the magnetic field emerging from the aperture into the magnetizable material.

FIG. 6B depicts an exemplary print head 106 having an insulating layer on first and second outer surfaces. More specifically, the print head 106 has a first insulating layer 602a on the bottom of the coil 502 and a second insulating layer 602b on the top of the coil.

FIG. 6C depicts an exemplary print head 106 where the coil 502 is encompassed by an insulating layer 602. FIG. 6C also depicts insulating layers surrounding the leads 506. Generally, such outer insulating layers are provided for safety reasons and/or to lower friction and wear on the head material, whereas insulating layers in between the layers of the multi turn flat metal coil are included such that they function as multiple turns of a coil.

FIG. 7A depicts a print head 106 like that of FIG. 5B having a flat magnetic shielding layer 702 (e.g., an iron or steel layer) beneath the print head 106, which is intended to shield the magnetizable material from magnetic fields at locations other than that emerging from the aperture 504 of the print head 106. As shown, the magnetic shielding layer 702 extends some distance outward from the perimeter of coil 502 of the print head 106 and has a hole 704 that corresponds to the aperture 504 of the print head 106, where the hole 704 of the magnetic shielding layer can be larger in diameter, smaller in diameter, or substantially the same size in diameter as the aperture 504 of the print head. Under one arrangement, the magnetic shielding layer 702 would be a round piece of metal having a diameter somewhat greater than the diameter of the coil 502. Under an alternative arrangement, the magnetic shielding layer 702 would have a diameter substantially the same as the diameter of the coil 502. Under yet another alternative arrangement, the magnetic shielding layer 702 would have a diameter less than the diameter of the coil 502.

FIG. 7B depicts a print head 106 like that of FIG. 5H having a magnetic shielding layer 702 that increases in thickness from its aperture to its outer boundary. Generally, the purpose of the magnetic shielding layer is to prevent magnetization by the coil 502 at locations on the magnetizable material other than at the desired maxel location, which is the area adjacent to the aperture of the coil. In particular, it is desirable to substantially prevent magnetization of the magnetizable material by magnetic fields present at the outer perimeter of the coil that have an opposite polarity than the desired polarity of the magnetic field present at the aperture of the coil. A given coil design relative to a given surface of a magnetizable material such as those shown in FIGS. 5C, 5E, 5F, and 5H, may provide space for increasing the thickness of a shielding layer away from the aperture thereby increasing and improving desired magnetic shielding effects.

FIG. 7C depicts a print head like 106 that of FIG. 5B having a flat magnetic shielding layer 702a beneath the print head and a flat magnetic shielding layer 702b on top of the print head. The addition of the second shielding layer 702b serves the purpose of improving efficiency of the print head by preventing magnetic field loss from the top side of the print head.

FIG. 7D depicts a print head 106 like that of FIG. 7C with a ferromagnetic core 708 inside the hole (or aperture) of the print head. The ferromagnetic core 708 serves to further increase the efficiency of the print head 106 and may extend from the top of the aperture of the coil to the bottom of the aperture of the coil. As shown in FIG. 7D, the core 708 is in contact with the top magnetic shielding layer 702b and is nearly but not in contact with the bottom magnetic shielding layer 702a.

Generally, magnetic shielding layers like those of FIGS. 7A-7D require a slot that extends from their center (e.g., from a central hole) to their circumference to prevent currents from flowing around them in a circuit thereby creating magnetic fields. FIG. 7E depicts an oblique projection view of a magnetic shielding layer 702 having such a slot 706 from a central hole 704 to its perimeter.

FIG. 7F depicts an exemplary print head 106 where the coil 502 is encompassed by a magnetic shielding layer 702 with a ferromagnetic core 708 inside the hole 504 of the print head. As shown, the core 708 extends from the top portion of the magnetic shielding layer 702 down through the top three layers of coil 502 of the print head but not into the portion of the hole 504 corresponding to the bottom layer of the coil 502 of the print head. Generally, various amounts of a core 708 can be used including having the core extend into the bottom portion of the shielding layer 702.

FIG. 7G depicts an oblique projection view of the print head 106 of FIG. 7F showing the slot 706 extended from the hole 704 to the perimeter of the magnetic shielding layer 702.

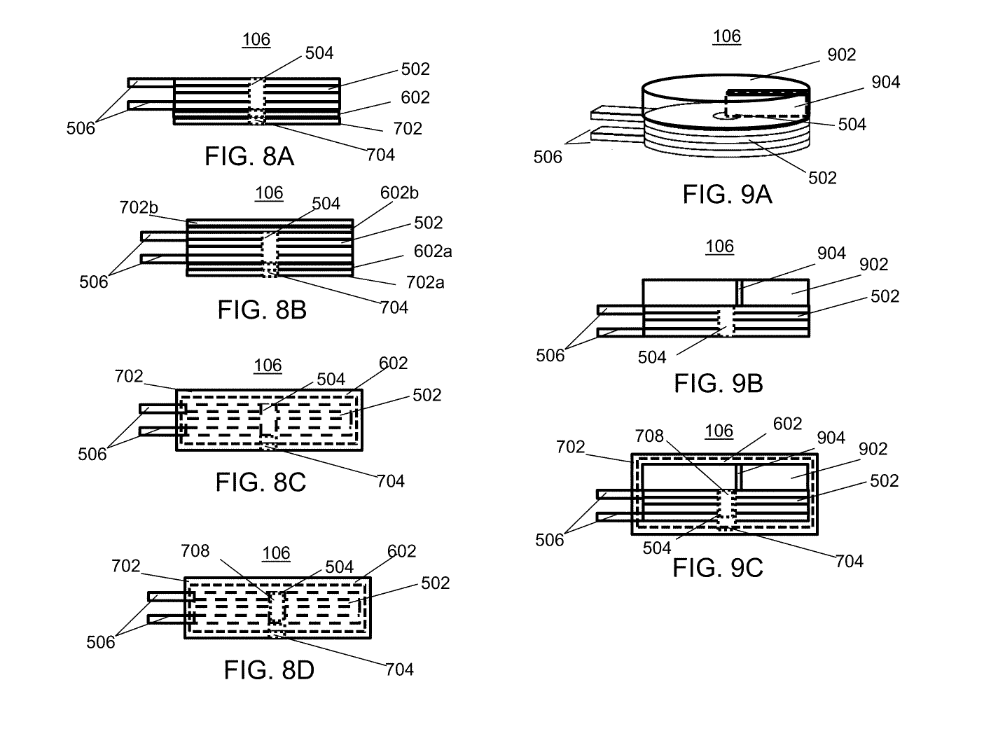

FIG. 8A depicts a print head 106 like that of FIG. 6A having a flat magnetic shielding layer 702 beneath the print head. Referring to FIG. 8A, an insulating layer 602 is beneath the multi turn flat metal coil 502 and a magnetic shielding layer 702 is beneath the insulating layer 602. Both the insulating layer 602 and the magnetic shielding layer are showing having holes that correspond to the aperture 504 of the print head 106. As described previously, the hole in the insulating layer 602 is optional.

FIG. 8B depicts a print head 106 like that of FIG. 6B having a flat magnetic shielding layer 702b on top of the print head. Referring to FIG. 8B, an insulating layer 602b is on top of the multi turn flat metal coil 502 and a magnetic shielding layer 702b is on top of the insulating layer 602b.

FIG. 8C depicts an exemplary print head 106 where the coil 502 is encompassed by an insulating layer 602 that is encompassed by a magnetic shielding layer 702.

FIG. 8D depicts an exemplary print head 106 like that of FIG. 8C with a ferromagnetic core 704 inside the hole 504 of the print head.

FIGS. 9A and 9B depict an exemplary print head 106 like that of FIGS. 5A-5C with an exemplary heat sink 902 that can be used to prevent the print head 106 from overheating during printing. As depicted, the heat sink 902, which can be copper, silver, or some other heat conductive material has a slot 904 extending from its outer periphery to the aperture 504 of the print head thereby preventing electric current from passing through it due to the changing flux in its vicinity. One skilled in the art of heat sinks will recognize that any of various forms of heat sink (or heat exchanger) methods can be employed to remove heat from a print head to include air cooling, fluid cooling, fin arrangements, and the like.

FIG. 9C depicts an exemplary print head 106 like that of FIGS. 9A and 9B where the coil 502 and heat sink 902 are encompassed by an insulating layer 602 that is encompassed by a magnetic shielding layer 702, where the insulating layer 602 and magnetic shielding layer 702 have holes corresponding to the aperture 504 of the print head. A ferromagnetic core 704 is shown filling the top portion of the coil hole 504.

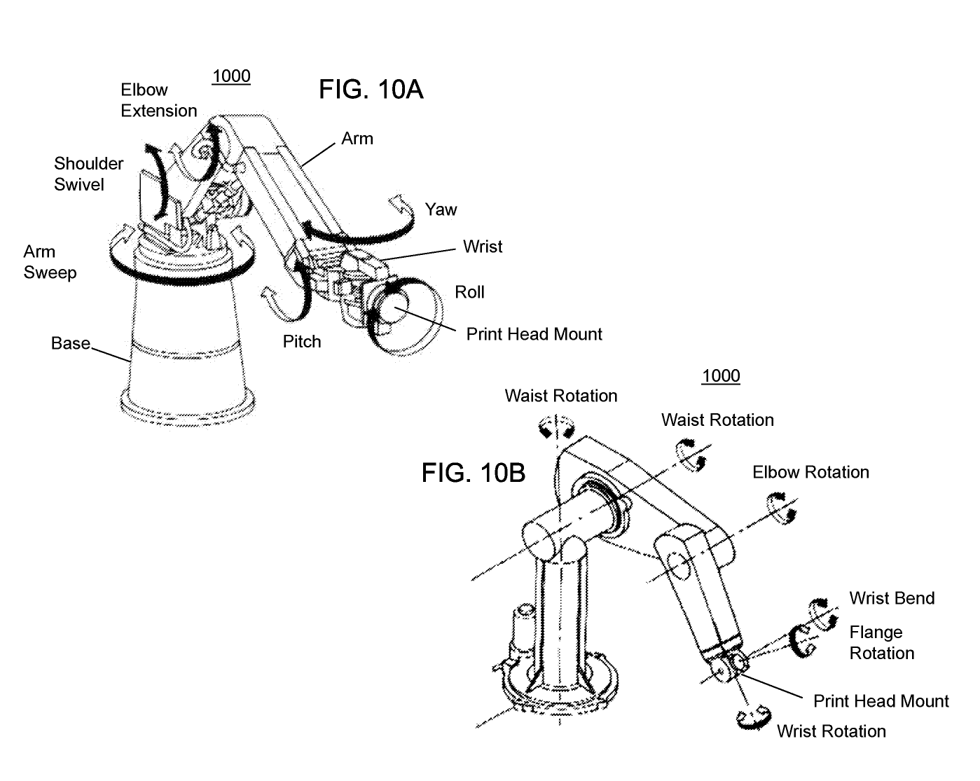

FIGS. 10A and 10B depict exemplary robotic arms 1000 on which print heads could be mounted in accordance with the present invention. Alternatively, magnetizable material could be mounted on the robotic arms 1000 instead of a print head.

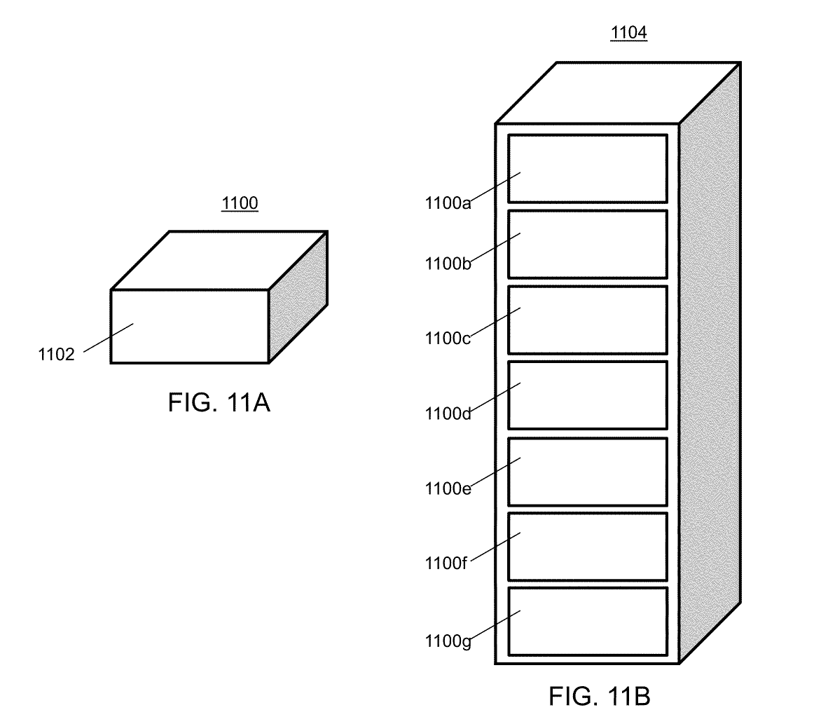

In accordance with one embodiment of the invention, one or more magnetization subsystems (i.e., magnetization components and wiring required to drive a single magnetizer print head) can be configured as a rack mount magnetization module, where one or more rack mount magnetization modules can be placed into an equipment rack. Each rack mount magnetization module has a power cord and a network connection and drives a magnetization print head. Each rack mount magnetization module has its own IP address. FIGS. 11A and 11B depict an exemplary rack mount magnetization module 1100 and rack mount system 1104, where the electrical components are inside an enclosure 1102 designed to be mounted in a rack mount system 1104. Seven rack mount magnetization modules 1100a-1100g are shown installed in the rack mount system 1104 of FIG. 11B.

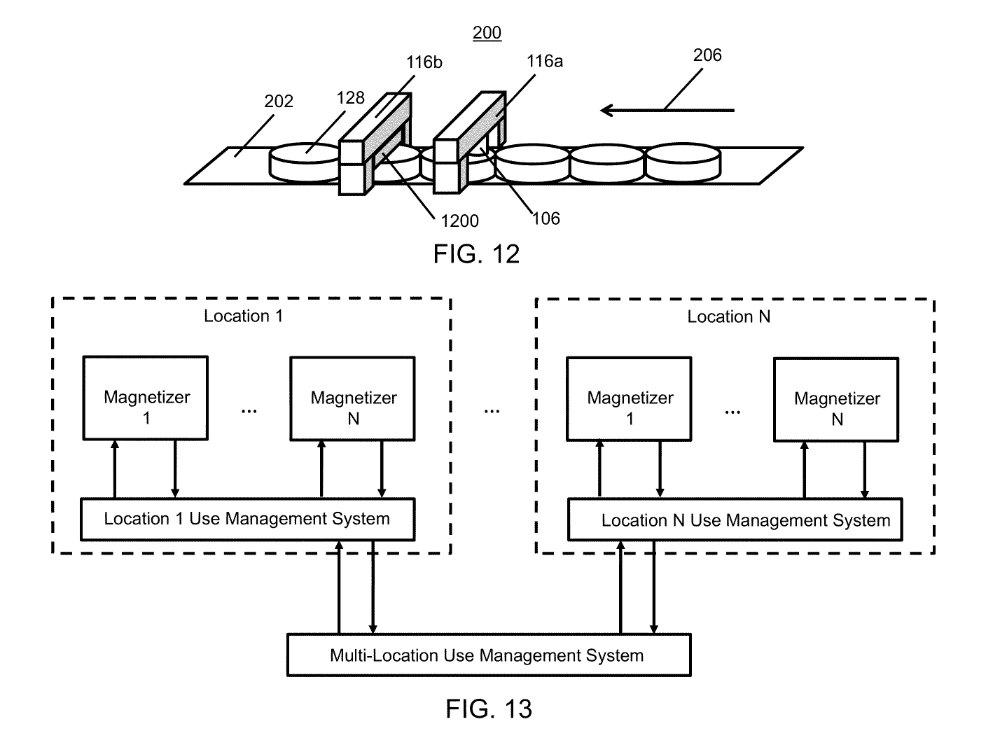

In accordance with another embodiment of the invention, a magnetic field measurement device is integrated with a magnetizer system to enable field scans to be produced as magnetic structures are being printed. The magnetic field measurement device may comprise one or more Hall Effect or magneto resistive or other magnetic sensors, for example, an array of Hall Effect sensors. Under one arrangement field scans of printed magnets are compared to a template field scan (i.e., a desired field scan) for quality control purposes and/or as part of magnetizer use management process. FIG. 12 depicts a conveyor-based magnetization system 200 having an integrated magnetic field measurement device 1200.

In accordance with one aspect of manufacturing a magnetic structure, one side of a magnetic structure is provided a ferromagnetic material plating of sufficient thickness to cause magnetic flux to be concentrated on the other side of the structure. The required thickness of the ferromagnetic material that is used for plating depends on the type of ferromagnetic material plated (e.g., Nickel, steel, etc.), the thickness of magnetizable material, and properties of the maxels printed onto the magnetizable material, but generally a ferromagnetic material plating can be provided that causes magnetic flux to concentrate on the other side of the structure. The metal plating functions as a shunt plate as described in U.S. Provisional Patent Application 61/459,994, filed Dec. 22, 2010, which is incorporated herein by reference.

In accordance with another embodiment of the invention, a magnetizer use management system and method can be employed to manage the use of magnetizers to print maxel patterns. As depicted in FIG. 13, each magnetizer at each location can be managed by a local use management system that provides authorized maxel print information to the magnetizers and collect maxel printing report information from the magnetizers. The authorized maxel print information may include authorized maxel patterns, permissions for printing a given number of magnetic structures having an authorized maxel pattern, magnetic structure identification information, and the like. Generally, each machine can be designed to respond to authorized commands used to control its printing process. Magnetic structure identification information may include a unique watermark (i.e., a detectable magnetic pattern used to authenticate that an authorized magnetizer produced the magnetic structure), which can be changed at any time, serial numbers, and the like. Maxel printing report information received from the magnetizers may include quality control information (e.g., field scans), performance metrics, health monitoring information, and the like that can be used to verify authorized use of the magnetizer, report unauthorized use, determine compliance with maintenance requirements, and the like.

Each local use management system can in turn interface with a multi-location use management system, which can interface with a next higher level management system, and so on, such that a hierarchy of use management systems and subsystems can be configured to manage use of large numbers of magnetizers over the Internet.

Various computer security methods can be employed as part of the use management system including data encryption between use management systems and magnetizer control systems, between different levels of use management systems, and between magnetizer control systems and magnetizer motion controllers.

In accordance with the invention, a current waveform of a print head can be monitored during the printing of a maxel, for example, using a current transformer, a Hall Effect sensor, a coil, etc. to produce current waveform characterization data. Such current waveform characterization data can be compared to established thresholds to assess quality of a waveform for quality control purposes and to recognize magnetizing circuit component failures (e.g., a failing capacitor, power supply, print head, etc.). By storing such data and analyzing trends component failures can be predicted before they occur. Such data enables safety measures to be designed into a magnetizing system such that the system will disable itself when current waveform characterization data is determined to be outside established thresholds.

In accordance with the invention a critical damping resistor is used in the magnetizing circuit that is designed to have low characteristic inductance and be able to withstand high average power and high peak power simultaneously. The critical damping resistor has enough conductance to provide electrical resistance yet not enough conductance to cause substantial current reversal and thereby prevents current oscillation through the print head. One approach to such a critical damping resistor is to employ multiple resistive wire conductors (e.g., 8 wires) in parallel where air cooling is used to reduce high average power and high integrity connections to the resistive wire conductors are used to allow for high peak power. Exemplary high average power might be on the order of 500 watts and exemplary high peak power might be on the order of 5 megawatts.

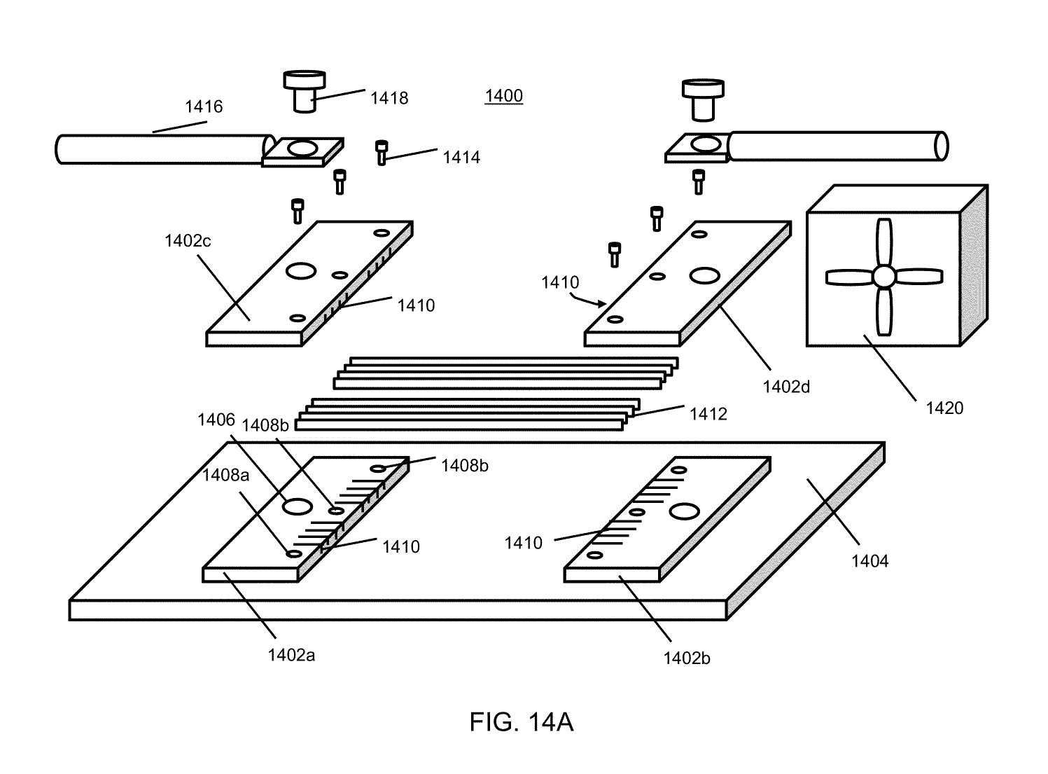

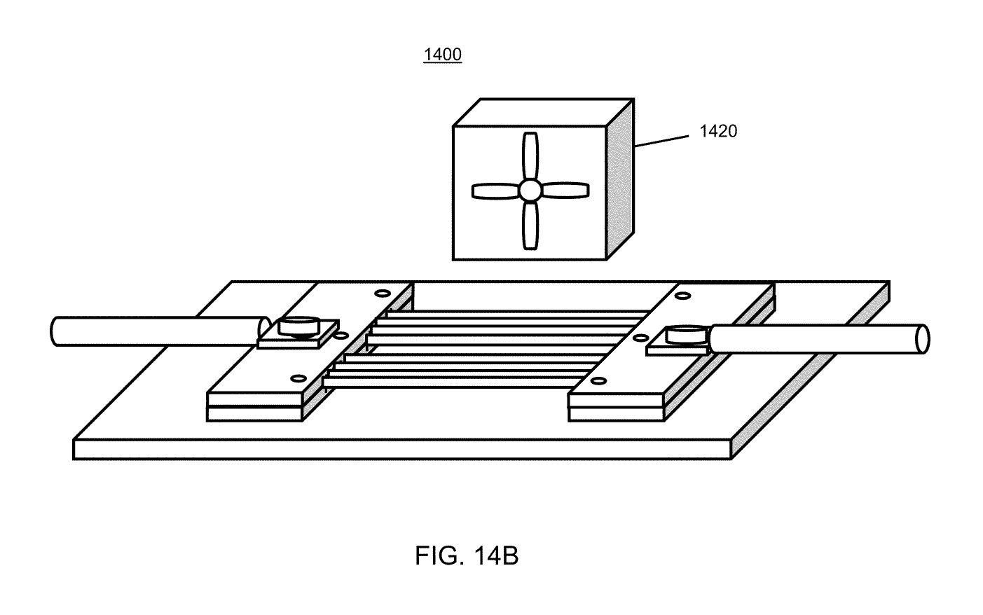

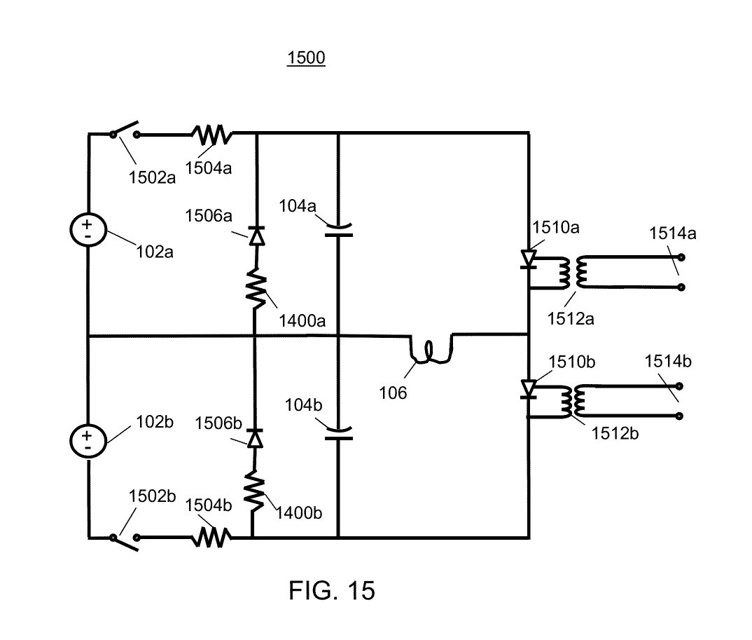

FIGS. 14A and 14B depict an exemplary critical damping resistor 1400 in accordance with the invention. Referring to FIG. 14A, exemplary critical damping resistor 1400 comprises four connector blocks 1402a-1402d made of a conducting material, for example, copper and a non-conductive plate 1404, which can be made of polycarbonate or other stiff material. The four connector blocks have large holes 1406 and three smaller holes 1408a-1408c. In between the three holes 1408a-1408c are two groups of four slots configured for receiving two groups of four conductive flat strips 1412, which may be for example copper strips. Also shown are small bolts for securing the connector blocks 1042a-1402d such that the four conductive flat strips 1412 are held tightly. Cables 1416 of the magnetizing circuit are attached to the four connector blocks 1402a-1402d using bolts 1418. A box fan 1420 is provided to blow air across the four conductive flat strips 1412 thereby cooling them during operation of the magnetic printer. The assembled critical damping resistor 1400 is shown in FIG. 14B.

FIG. 15 depicts an exemplary bipolar magnetizing circuit 1500 in accordance with the invention. Referring to FIG. 15, the bipolar magnetizing circuit 1500 includes two high voltage power supplies 102a 102b, two charging switches 1502a 1502b, two charging resistances 1504a 1504b, two back diodes 1506a 1506b, two energy storage capacitors 104a 104b, two critical damping resistors 1400a 1400b, two silicon controlled rectifiers (SCRs) 1510a 1510b, two pulse transformers 1512a 1512b, and a print head 106. The pulse transformers 1512a 1512b receive trigger pulses at leads 1514a 1514b to trigger respective SCRs 1510a 1510b. The trigger pulses are provided by a computerized control system (not shown).

In accordance with the invention a reflective suppression circuit is used to absorb the inductive energy produced by the wiring of the magnetization circuit and the print head itself during magnetization of a maxel. More specifically, the reflective suppression circuit is used to cause the magnetizing field to collapse at an as fast as practical rate which prevents the inductive energy from being absorbed by the head thereby preventing heating of the head and substantially shortening the magnetizing pulse. The reflective suppression circuit comprises one or more diodes, which may be referred to as back diodes, that shunt the magnetizing current into the dampening resistor previously described.

In accordance with the invention, sensors can be employed to measure various physical parameters of components of the magnetic printer and the magnetic printer's environment. Measurement data produced by the sensors can be provided to a health monitoring system and otherwise stored for analysis and other purposes. Such parameters may include temperature, humidity, current, voltage, magnetic field, and the like.

In accordance with the invention, one or more cameras can be used as part of a machine vision subsystem used for auto-alignment of magnetizable materials (e.g., flexible materials on a vacuum fixture) for printing, scanning, etc. One or more cameras can be configured to provide a view angle substantially perpendicular to the surface of a material so as to provide images that can be processed to determine location and orientation of material relative to an established coordinate system whereby the coordinate system or the positions of the code defining a print pattern can be rotated and/or translated as required to print maxels at the desired locations on the material. One or more cameras can be configured to provide a view angle substantially parallel to the surface of a material so as to determine clearances to ensure a print head doesn't collide with material, which could damage the print head and/or the material.

In accordance with the invention, a maxel pattern can be magnetized onto a magnetic material being printed to produce a magnetic structure to be used for an application to provide information relating to the magnetic structure. For example, a maxel pattern corresponding to a bar code or QR code could be magnetized onto a material. Under one arrangement, the maxel pattern could be amplitude modulated and a field scan could be used to read the bar code or QR code. Under another arrangement, the maxel pattern could be a two dimensional derivative surface where the bar code or QR code could be read with magnetic viewing film. The bar code or QR code could provide information that identifies a particular magnetic structure and could provide information about its manufacture (e.g., date, time, magnetic printer used, etc.). Similarly, a fixture used to hold material during printing of maxels could have a piece of magnetic material permanently on the surface of the fixture that can be printed with an identification code (e.g., barcode or QR code), and that code could follow the fixture through the subsequent manufacturing stages for example to determine which processing line it heads off to, where it should be sent for storage or shipping, etc. The identification code can be rewritten each type the fixture is used.

In accordance with another aspect of the invention, a positioning system and method involves a wire placed on an object (e.g., a fixture) and an A/C current is passed through the wire. Magnetic fields produced by the A/C current on each side of the wire are equal and opposite in polarity. As such, a position of the wire can be determined by locating a zero crossing of sensor information pertaining to a position directly over the wire. A sensor such as a Hall Effect sensor or a coil can be used to measure the magnetic fields. Under one arrangement two sensors are used where one sensor is on one side of the wire and the other sensor is on the opposing side of the wire. When they are measuring equal but opposite field strengths they are equally spaced from the wire. Alternatively, a single sensor can be moved relative to the wire and will measure zero when directly over the wire. This effect can be operated in reverse where the A/C current can be induced into the wire by the external coils and current circulating in the wire can be used to sense the position of the wire. The print head can act as the coil that provides a position sensitive current pulse to the wire. Under one arrangement, the sensor can be moved back and forth in a binary tree scanning mode and in another arrangement a phase lock loop can determine the zero point.

In accordance with the invention insulating microbeads (i.e., uniform particles) are placed into an insulating liquid in which an inductor coil (e.g., print head) can be dipped and the liquid allowed to harden. The microbeads have a desired size (e.g., diameter) corresponding to a desired separation distance between coil layers. The insulating liquid having the insulating microbeads is forced through the coil using a pressure or a vacuum to provide a coating of the coil layers. The coil is then compressed while the liquid is allowed to harden such that after it is hardened the coil layers are separated by the desired separation distance. Microbeads may be made of any well know insulating material such as a polymer, glass, ceramic, or the like. An insulating liquid that will harden may be an epoxy, an acrylic, a polymer, or the like and can be solvent based.

In accordance with the invention, the print head fixture is designed such that the hole of each print head in a given fixture is located at common reference point. As such, when one fixture has been aligned then all comparable ones will be aligned also. Generally, having a common reference point on fixtures allows multiple fixtures to be used once any one has been aligned.

While particular embodiments of the invention have been described, it will be understood, however, that the invention is not limited thereto, since modifications may be made by those skilled in the art, particularly in light of the foregoing teachings.

1. A magnetizer for magnetizing one or more magnetic field sources into a magnetizable material, comprising:
a first magnetization subsystem, said magnetization subsystem comprising:
a magnetizing inductor, comprising:
a plurality of flat conductor layers; and
a plurality of insulating layers, said plurality of flat conductor layers and said plurality of insulating layers forming multiple turns of a coil, said magnetizing inductor having an aperture extending through said plurality of flat conductive material layers; and
a magnetization circuitry for applying a current to said magnetizing inductor to generate a magnetizing field having a high magnetic flux density in and near said aperture that is sufficient to magnetize said magnetizable material and having a low magnetic flux density elsewhere that is insufficient to substantially magnetize said magnetizable material;
a motion control subsystem for moving at least one of said magnetizable material or said magnetizing inductor to position said aperture of said magnetizing inductor adjacent to one or more locations at a surface of said magnetizable material where said one or more magnetic field sources are magnetized into said magnetizable material, said one or more magnetic field sources having a first polarity exposed at the surface of said magnetizable material and a second polarity not exposed at the surface of said magnetizable material; and
a magnetizer control system for controlling said first magnetization subsystem and said motion control subsystem.

2. The magnetizer of claim 1, wherein said magnetization circuitry is a monopolar magnetization circuitry.

3. The magnetizer of claim 1, wherein said magnetization circuitry is a bipolar magnetizing circuitry.

4. The magnetizer of claim 1, wherein said magnetizer control system can change the direction of said current applied to said magnetizing inductor.

5. The magnetizer of claim 1, wherein said magnetizer control system can change the amount of said current applied to said magnetizing inductor.

6. The magnetizer of claim 1, further comprising:
a second magnetization subsystem.

7. The magnetizer of claim 6, wherein two magnetic field sources of said one or more magnetic field sources are magnetized at substantially the same time.

8. The magnetizer of claim 6, wherein said magnetizing inductor of said first magnetization subsystem and a magnetizing inductor of said second magnetization subsystem are on opposite sides of said magnetizable material.

9. The magnetizer of claim 1, further comprising:
a monitoring device for monitoring a current waveform of said magnetizing inductor during magnetizing of said magnetizable material to produce current waveform characterization data.

10. The magnetizer of claim 9, wherein said magnetizer can disable itself when said current waveform characterization data is determined to be outside an established threshold.

11. The magnetizer of claim 1, further comprising:
a sensor for measuring a physical parameter of one of a component of the magnetizer or the magnetizer's environment.

12. The magnetizer of claim 1, further comprising:
a camera.

13. The magnetizer of claim 1, wherein a pattern of said one or more magnetic field sources provides information.

14. The magnetizer of claim 1, wherein said plurality of insulating layers comprise uniformly sized particles placed into an insulating liquid that is then allowed to harden while said coil is compressed.

15. The magnetizer of claim 14, wherein said uniformly sized particles are one of a polymer, a glass, or a ceramic.

16. The magnetizer of claim 14, wherein said insulating liquid is one of an epoxy, an acrylic, a polymer, or solvent based.

17. The magnetizer of claim 1, further comprising:
a software configured to define the location, polarity, and field amplitude of each magnetic field source of said one or more magnetic field sources.

18. The magnetizer of claim 1, further comprising:
a fixture for holding said magnetizable material during magnetization of said one or more magnetic field sources.

19. The magnetizer of claim 1, further comprising:
at least one of a turn table or a conveyor system.

20. The magnetizer of claim 1, further comprising:
a magnetic shielding layer.
